(19) United States
(12) Patent Application Publication
(10) Pub. No.: US 2009/0177374 A1
(43) Pub. Date: Jul. 9, 2009

(54) Method for real-time updating background weather patern of electronic map

(75) Inventor: Neng Liu, Hsinchu City (TW)

Correspondence Address: BACON & THOMAS, PLLC, 625 SLATERS LANE, FOURTH FLOOR, ALEXANDRIA, VA, 22314-1176, US

(73) Assignee: Mitac Internation Corp., Taoyuan (TW)

(21) Appl. No.: 12/153,470

(22) Filed: May 20, 2008

(30) Foreign Application Priority Data
Jan. 9, 2008 (TW) 097100880

(51) Int. Cl. G01C 21/00

(52) U.S. Cl. 701/200

(57) ABSTRACT

A method for a navigation device to change a background weather pattern of an electronic map comprises steps of: reading a plurality of positioning signals received by a positioning module and calculating a current location of the navigation accordingly; reading from a map database and a real-time weather database, respectively, an electronic map and a background weather pattern that correspond to the current location, and outputting the electronic map and the background weather pattern corresponding to the current location on a display device; determining whether it is necessary to change the electronic map corresponding to the current location; and when it is necessary, reading from the real-time weather database a background weather pattern corresponding to an updated current location and replacing the presently displayed electronic map and background weather pattern with an electronic map and a background weather pattern corresponding to the updated current location.

### FIELD OF THE INVENTION

The present invention relates to a method for real-time updating a background weather pattern of an electronic map and, more particularly, to a method applied to a navigation device for enabling the navigation device to display a background weather pattern corresponding to a current location on a display device thereof while displaying an electronic map of the current location on the display device.

### BACKGROUND OF THE INVENTION

Referring to FIG. 1, a car navigation device 1 comprises a Global Positioning System (GPS) 10 and a map database 12. The car navigation device 1 outputs an electronic map 140 (as shown in FIG. 2) on a display device 14 thereof according to the map database 12 and uses the principle of dead reckoning to calculate a speed and a direction between a previous location and a current location so as to show a mark 142 indicating a current location, a moving direction and a speed of a car on the electronic map 140.

Referring again to FIG. 1, the car navigation device 1 can further comprise a navigation software 16, with which the car navigation device 1 calculates a navigation path (such as each of the hatched roads in FIG. 2) between a starting point 144 and a terminal point 146 on the electronic map 140 based on different navigation conditions (such as distances, road types, means of transportation, etc.). When a driver selects a particular navigation path, a corresponding route will be shown on the electronic map 140 for the driver's reference. If the car navigation device 1 determines that the current location of the car, which is calculated via the navigation software 16 according to positioning signals of the GPS 10, has deviated from that particular navigation path, the car navigation device 1 can use the navigation software 16 to plan a new navigation path based on the current location of the car and the terminal location. Thus, through collaboration among the GPS 10, the map database 12 and the navigation software 16, the car navigation device 1 displays navigation paths to guide the driver from the starting point 144 to the terminal point 146.

While the car navigation device 1 can use the navigation software 16 to compute and plan different navigation paths according to different navigation conditions, the starting point 144 and the terminal point 146 before the driver hits the road, routine traffic congestion or accidents (such as car accidents or road constructions) on certain roads will force the driver to abandon the planned navigation paths and choose an alternate driving route to avoid being stuck in the traffic jam. Therefore, from the driver's point of view, if the car navigation device 1 can plan dynamically an optimal driving route based on real-time traffic conditions, the driving time will be effectively reduced as the navigation quality is improved. Hence, real-time navigation services integrated with various wireless communication techniques and real-time traffic information have emerged.

For example, both XM Satellite Radio (offering a service called XM NavTraffic) and Sirius Satellite Radio send the latest traffic information including driving speeds, locations of car accidents and road construction sites, etc. to the car navigation device 1 through satellite broadcasting, so that the car navigation device 1 can plan an optical driving route based on such information. In addition, while on the route, the car navigation device 1 can receive signals advising the driver to detour in case of a car accident ahead and informing the driver of the time needed to reach the destination.

As another example, the car navigation device 1 can be adapted to receive a real-time traffic and weather information broadcast on a Radio Data System (RDS) or a real-time Traffic Message Channel (TMC) based on a wireless frequency modulation (FM) technology to obtain the following contents:

(1) areas, roads and directions affected by current traffic accidents;
(2) possible durations of the traffic accidents or of current weather conditions; and
(3) recommended alternative driving routes based on the aforesaid information, wherein the traffic information is updated every five minutes.

In RDS/TMS as well as in satellite broadcasting, the traffic information is generally gathered through local traffic authorities and roadside sensors and cameras, before it is compiled and analyzed.

In addition to real-time navigation services provided via the aforementioned two wireless communication techniques, similar services are now available through Digital Audio Broadcast (DAB) or GSM/GPRS and other cell phone networking techniques.

In either case, however, when the car navigation device 1 displays an electronic map 140, a weather information is not displayed prominently on the display device 14, but shown only when the car navigation device 1 is switched to a corresponding mode, or alternatively, shown only at a corner of the display device 14. As long as real-time weather information cannot be displayed prominently on the electronic map 140 without additional operation by the driver, or is displayed only in small fonts or as a small pattern at a corner of the display device 14, the inconvenience and troubles associated with the display of real-time weather information persist. Therefore, it is necessary to improve the way existing navigation devices display real-time weather information.

### SUMMARY OF THE INVENTION

In view of the aforementioned shortcomings of prior art and after years of research and experiments, the present inventor finally succeeded in developing a method for real-time updating a background weather pattern of an electronic map as disclosed herein, with the aims of solving the problem that a traditional navigation device only displays on a display device thereof an electronic map having a monotonous background and cannot reflect real-time weather conditions.

Therefore, an objective of the present invention is to provide a method for real-time updating a background weather pattern of an electronic map. The method is applicable to a navigation device comprising a map database, a real-time weather database, a positioning module and a real-time information module, wherein the map database is preset with electronic maps of a plurality of districts, and the real-time weather database stores a real-time weather information of each said district received by the real-time information module and a plurality of background weather patterns designed for different weathers. When the navigation device is actuated to perform a positioning or navigation function, the method according to the present invention for the navigation device to real-time update a background weather pattern of an electronic map comprises steps of: reading a plurality of positioning signals received by the positioning module and calculating a current location of the navigation device according to the positioning signals; reading from the map database and the real-time weather database, respectively, one of said electronic maps and one of said background weather patterns that correspond to one of said districts where the current location belongs, and outputting the electronic map and the background weather pattern corresponding to the current location on a display device of the navigation device; determining whether or not it is necessary to change the electronic map corresponding to the current location; and if it is necessary, reading from the real-time weather database one of said background weather patterns that corresponds to an updated current location and replacing the electronic map and the background weather pattern presently displayed on the display device with one of said electronic maps and one of said background weather patterns that correspond to the updated current location. Thus, the pattern displayed by the navigation device is no more monotonous, and a driver is allowed to clearly see real-time weather changes from an electronic map shown on the display device of the navigation device, thereby solving the problem of the traditional navigation device that a driver is not allowed to see a weather condition corresponding to a current location when the traditional navigation device displays an electronic map on a display device thereof.

### BRIEF DESCRIPTION OF THE DRAWINGS

The invention as well as a preferred mode of use, further objectives and advantages thereof will best be understood by reference to the following detailed description of an illustrative embodiment when read in conjunction with the accompanying drawings, wherein:

FIG. 1 is a schematic drawing showing a structure of a conventional navigation device;

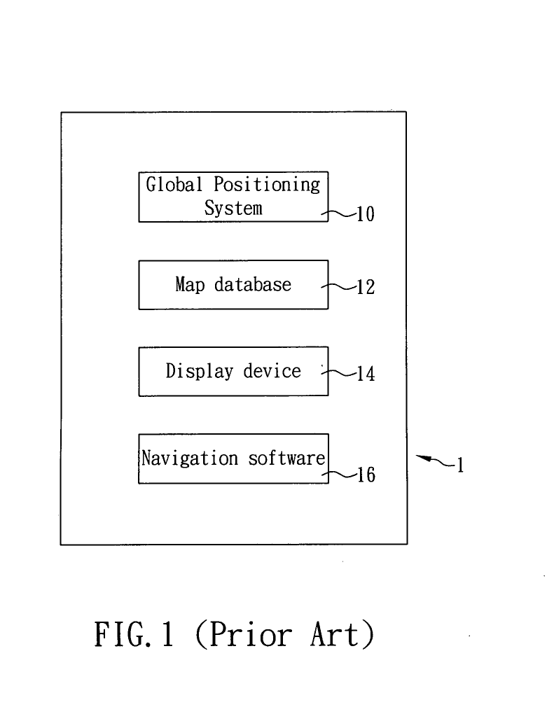

FIG. 2 is a schematic drawing of an electronic map outputted on a display device of the conventional navigation device;

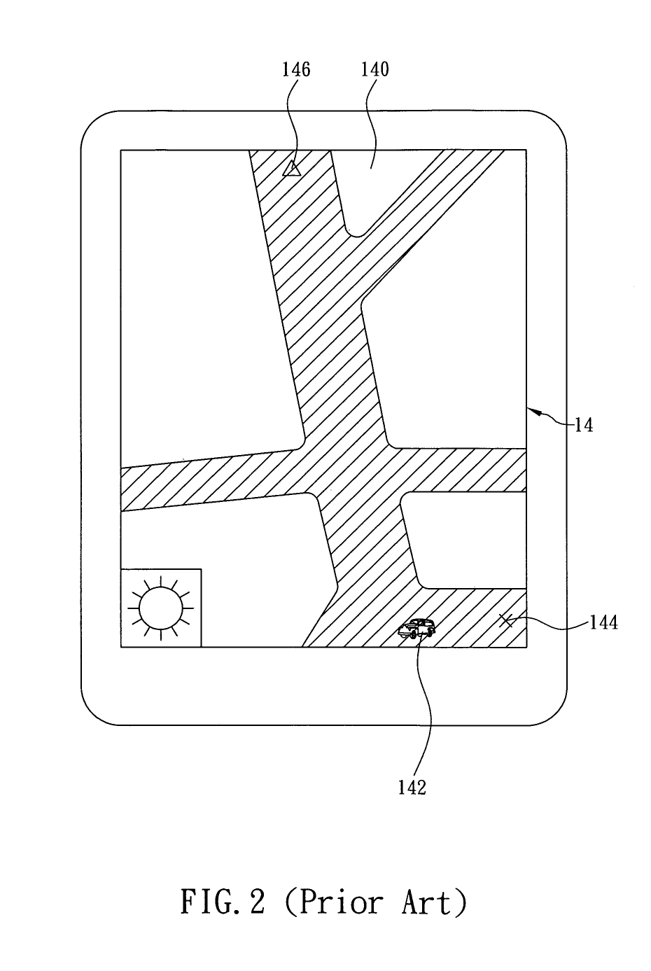

FIG. 3 is a schematic drawing showing a structure of a navigation device adapted to a method of the present invention;

FIG. 4 is a flowchart for the navigation device to real-time update a background weather pattern of an electronic map according to the present invention;

FIG. 5 is a flowchart for the navigation to read positioning signals and calculate a current location according to the present invention;

FIG. 6 is another flowchart for the navigation to read positioning signals and calculate a current location according to the present invention;

FIG. 7 is a schematic drawing of an electronic map and a background weather pattern outputted on a display device of the navigation device according to the present invention;

FIG. 8 is a flowchart for the navigation device to determine whether it is necessary to change an electronic map corresponding to the current location according to the present invention; and

FIG. 9 is a schematic drawing of an electronic map and a background weather pattern that have been updated on the display device of the navigation device according to the present invention.

### DETAILED DESCRIPTION OF THE PREFERRED EMBODIMENTS

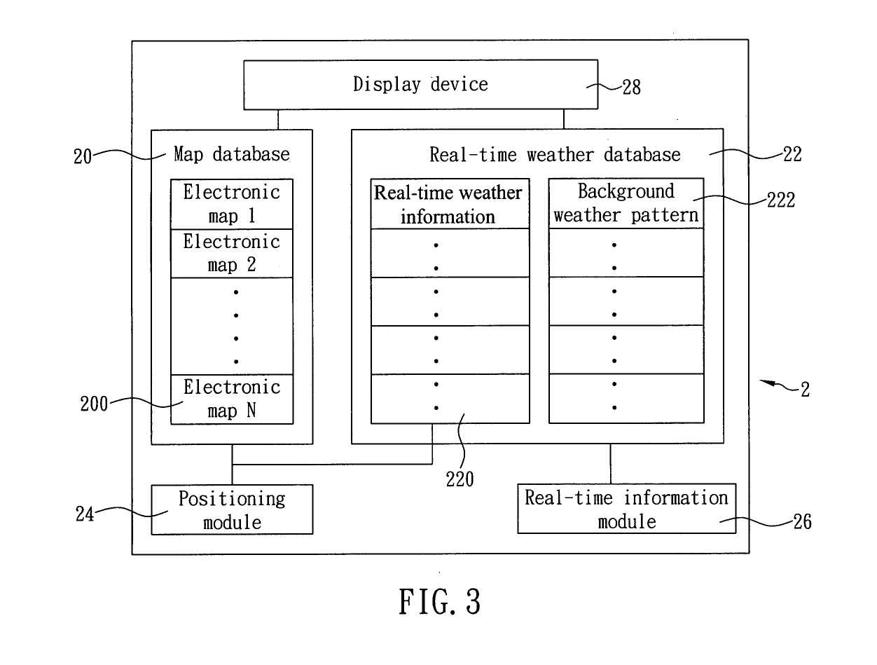

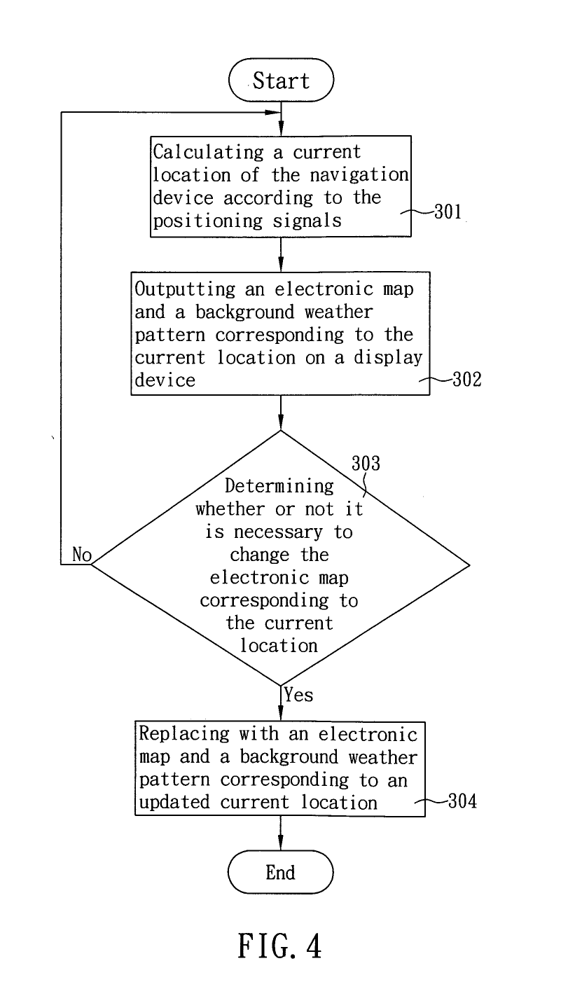

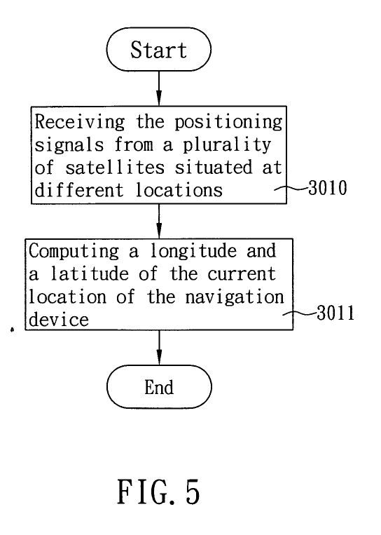

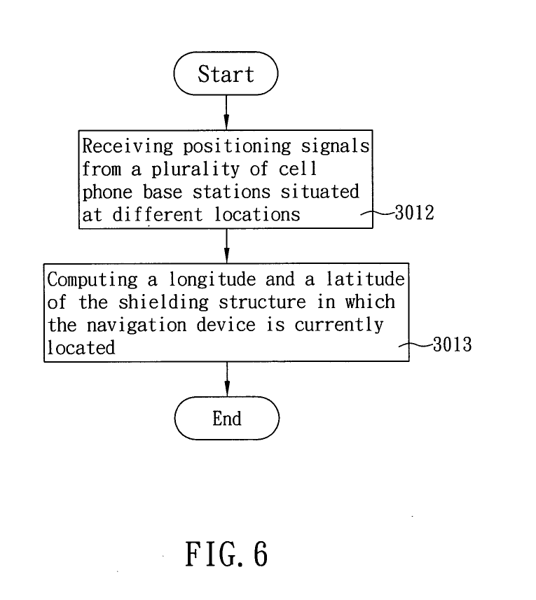

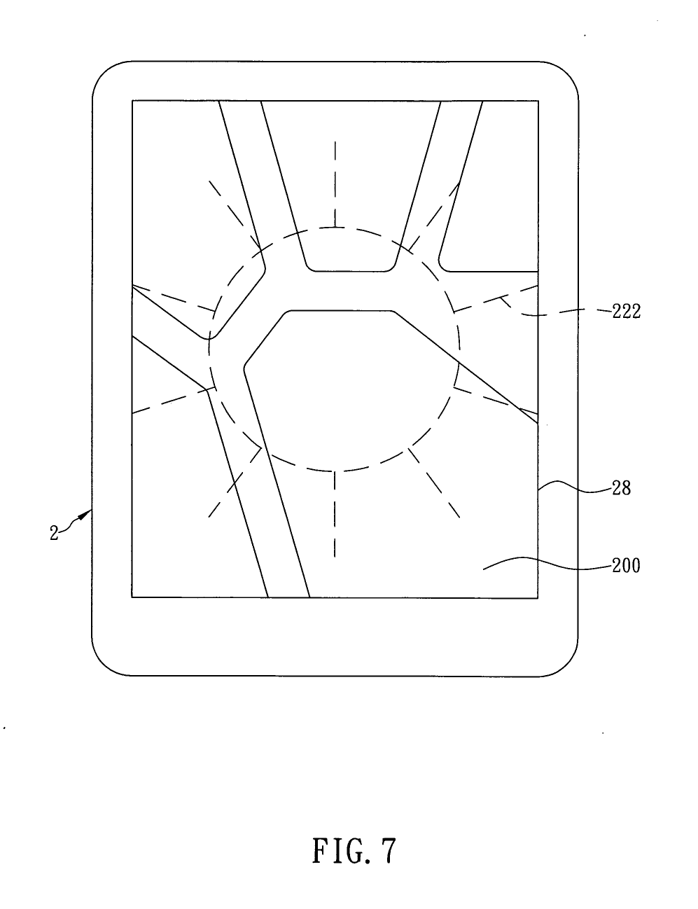

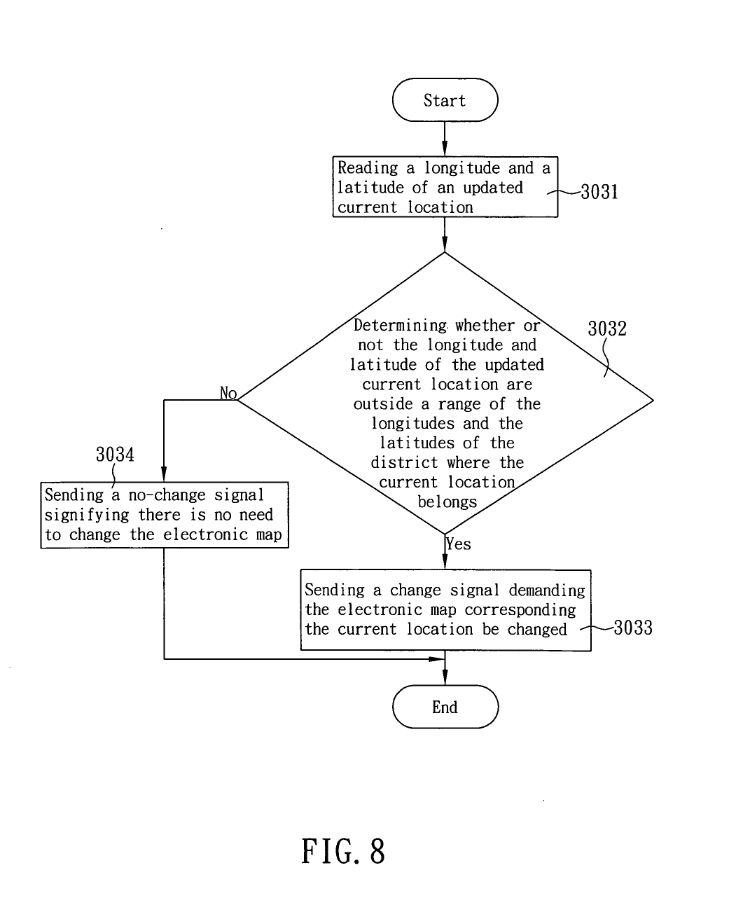

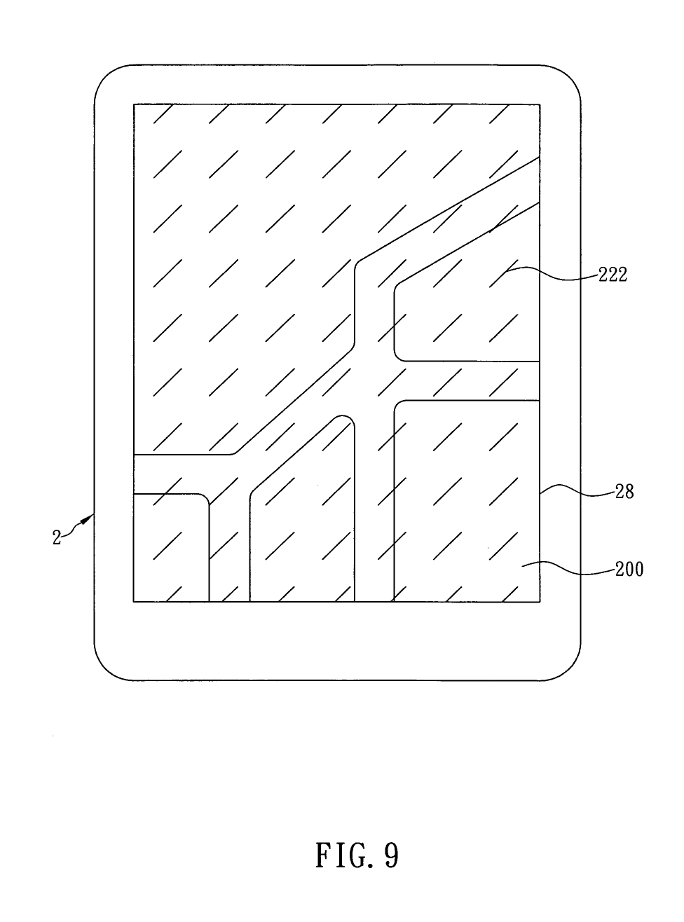

Referring to FIG. 3, a method for real-time updating a background weather pattern of an electronic map according to the present invention is applied to a navigation device 2 comprising a map database 20, a real-time weather database 22, a positioning module 24 and a real-time information module 26, wherein the map database 20 is preset with electronic maps 200 of a plurality of districts (such as cities, towns, etc.) and the real-time weather database 22 stores a real-time weather information 220 of each said district received by the real-time information module 26 and a plurality of background weather patterns 222 designed for different weathers (such as a sunny day, a cloudy day, a rainy day, snow, typhoons, etc.). Referring to FIG. 4, when the navigation device 2 is actuated to perform a positioning or navigation function, the method according to the present invention for the navigation device 2 to real-time update a background weather pattern 222 of an electronic map 200 comprises steps of:
(301) reading a plurality of positioning signals received by the positioning module 24, and calculating a current location of the navigation device 2 according to the positioning signals, wherein, in a preferred embodiment of the present invention, the positioning module 24 is a Global Positioning System and, when the navigation device 2 reads the positioning signals and calculates the current location, performs, as shown in FIG. 5, steps of:
   (3010) receiving the positioning signals from a plurality of satellites situated at different locations (at least four satellites situated at different locations); and
   (3011) using at least one satellite signal computing technique (such as Differential GPS; DGPS) to compute the positioning signals so as to determine a longitude and a latitude of the current location of the navigation device 2;
so that, as long as the navigation device 2 is at an outdoor location where it can receive such positioning signals, the current location of the navigation device 2 can be determined accordingly; in which the positioning module 24 further comprises an Assisted Global Positioning System (AGPS) in the preferred embodiment of the present invention to cope with such occasions as when the navigation device 2 is in a shielding structure (such as a tunnel, a building, an underpass, etc.) where the navigation device 2 cannot receive the positioning signals from the satellites and the positioning module 24 is thus prevented from accurately calculating the current location of the navigation device 2, so that, when the positioning module 24 cannot receive the positioning signals from the satellites, the positioning module 24 performs, as shown in FIG. 6, steps of:
   (3012) receiving positioning signals from a plurality of cell phone base stations situated at different locations; and
   (3013) using at least one base-station signal computing technique to compute the positioning signals of the base stations so as to determine a longitude and a latitude of the shielding structure in which the navigation device 2 is currently located, wherein the base-station signal computing technique can be, for example, based on a signal intensity, such as a time of arrival (TOA) technique, in which distances between the navigation device 2 and the base stations are measured by the signal intensity therebetween, or based on a signal transmission angle, such as an angle of arrival (AOA) technique, in which the current location of the navigation device 2 is determined by computing angles of signals transmitted from two or more base stations to the navigation device 2;
so that, when the navigation device 2 is in the shielding structure where it cannot receive the positioning signals from the satellites, the positioning module 24 can still use the positioning signals from the base stations to calculate the current location of the navigation device 2;
(302) reading from the map database 20 and the real-time weather database 22, respectively, an electronic map 200 and a background weather pattern 222 that correspond to the district where the current location belongs, and outputting the electronic map 200 and the background weather pattern 222 corresponding to the current location on a display device 28 of the navigation device 2 (as shown in FIG. 7), wherein, in the preferred embodiment of the present invention, the electronic map 200 of each district in the map database 20 contains a distribution of all roads in each said district and a longitude and a latitude of each said road, while the real-time weather database 22 further comprises longitudes and latitudes in each said district in the map database 20, so that the navigation device 2 can compare the longitude and latitude of the current location with the longitudes and the latitudes in the map database 20 and in the real-time weather database 22, invoke from the map database 20 one of the electronic maps 200 that corresponds to the current location, invoke from the real-time weather database 22 one of the background weather patterns 222 that corresponds to the current location, and then display the electronic map 200 and the background weather pattern 222 corresponding to the current location on the display device 28 of the navigation device 2, whereby the navigation device 2 outputs the correct electronic map 200 and background weather pattern 222;
(303) determining whether or not it is necessary to change the electronic map 200 corresponding to the current location, and proceeding to step (304) if yes and back to step (301) if no, wherein, in the preferred embodiment of the present invention, the navigation device 2 determines whether or not it is necessary to change the electronic map 200 corresponding to the current location by performing, as shown in FIG. 8, steps of:
   (3031) reading a longitude and a latitude of an updated current location;
   (3032) determining whether or not the longitude and the latitude of the updated current location are outside a range of the longitudes and the latitudes of the district where the current location belongs, and proceeding to step (3033) if yes and step (3034) if no;
   (3033) sending a change signal demanding the electronic map 200 corresponding the current location be changed, and proceeding to step (304) for replacing the electronic map 200 corresponding to the current location; or
   (3034) sending a no-change signal signifying there is no need to change the electronic map 200, and returning to the step (301) for reading another plurality of positioning signals received by the positioning module 24; and
(304) reading the background weather pattern 222 corresponding to the updated current location from the real-time weather database 22, and replacing the electronic map 200 and the background weather pattern 222 presently displayed on the display device 28 with an electronic map 200 and a background weather pattern 222 corresponding to the updated current location (as shown in FIG. 9), wherein, in the preferred embodiment of the present invention, the navigation device 2 replaces the electronic map 200 and the background weather pattern 222 presently displayed on the display device 28 with the electronic map 200 and the background weather pattern 222 corresponding to the updated current location also by comparing a longitude and a latitude of the updated current location with the longitudes and the latitudes in the map database 20 and in the real-time weather database 22, invoking from the map database 20 one of the electronic maps 200 that corresponds to the updated current location and invoking from the real-time weather database 22 one of the background weather patterns 222 that corresponds to the updated current location, thereby replacing the electronic map 200 and the background weather pattern 222 that correspond to the current location and are presently displayed on the display device 28 of the navigation device 2.

Thus, the display device 28 will display an electronic map 200 and a background weather pattern 222 no matter whether the navigation device 2 is performing a positioning or navigation function. Moreover, as the navigation device 2 is moved to different districts, the display device 28 will display an electronic map 200 and a background weather pattern 222 that correspond to each said district. Therefore, the patterns displayed by the navigation device 2 are no more monotonous, and a driver can clearly see real-time weather changes from an electronic map 200 shown on the display device 28 of the navigation device 2, thereby solving the problem of the traditional navigation device that a driver is not allowed to see a weather condition corresponding to a current location when the traditional navigation device displays an electronic map on a display device thereof.

In the preferred embodiment of the present invention, the real-time information module 26 is a Radio Data System that uses a wireless frequency modulation technique to receive a real-time weather information of each district, or alternatively a Digital Audio Broadcast system that uses a digital broadcasting technique to receive a real-time weather information of each district. In either case, the navigation device 2 will store the real-time weather information in the real-time weather database 22, so that the background weather pattern 222 displayed on the display device 28 of the navigation device 2 reflects the real-time weather information 220 of the current location. Thus, a driver does not need to repeatedly switch the navigation device 2 between a navigation mode and a weather information inquiry mode. And by minimizing the driver's operation of the navigation device 2 during driving, driving safety is secured.

The present invention has been described with the preferred embodiment thereof and it is understood that the embodiment is not intended to limit the scope of the present invention. Moreover, as the content disclosed herein should be readily understood and can be implemented by a person skilled in the art, all equivalent changes or modifications which do not depart from the spirit of the present invention are encompassed by the appended claims.

1. A method for real-time updating a background weather pattern of an electronic map, applicable to a navigation device comprising a map database, a real-time weather database, a positioning module and a real-time information module, wherein the map database is preset with electronic maps of a plurality of districts, and the real-time weather database stores a real-time weather information of each said district received by the real-time information module and a plurality of background weather patterns designed for different weathers;
the method for the navigation device, when actuated to perform a positioning or navigation function, to real-time update a background weather pattern of an electronic map comprising steps of:
reading a plurality of positioning signals received by the positioning module, and calculating a current location of the navigation device according to the positioning signals;
reading from the map database and the real-time weather database, respectively, one of said electronic maps and one of said background weather patterns that correspond to one of said districts where the current location belongs, and outputting the electronic map and the background weather pattern corresponding to the current location on a display device of the navigation device;
determining whether or not it is necessary to change the electronic map corresponding to the current location; and
when it is necessary to change the electronic map corresponding to the current location, reading from the real-time weather database one of said background weather patterns that corresponds to an updated current location and replacing the electronic map and the background weather pattern presently displayed on the display device with one of said electronic maps and one of said background weather patterns that correspond to the updated current location.

2. The method as claimed in claim 1, wherein the positioning module is a Global Positioning System and, when the navigation device reads the positioning signals and calculates the current location, performs steps of:
receiving the positioning signals from a plurality of satellites situated at different locations; and
using at least one satellite signal computing technique to compute the positioning signals so as to determine a longitude and a latitude of the current location of the navigation device.

3. The method as claimed in claim 2, wherein the positioning module further comprises an Assisted Global Positioning System and, when the navigation device cannot read the positioning signals from the satellites, performs steps of:
receiving positioning signals from a plurality of cell phone base stations situated at different locations; and
using at least one base-station signal computing technique to compute the positioning signals of the base stations so as to determine a longitude and a latitude of a shielding structure in which the navigation device is currently located.

4. The method as claimed in claim 3, wherein the electronic map of each said district in the map database contains a distribution of all roads in each said district and a longitude and a latitude of each said road.

5. The method as claimed in claim 4, wherein the real-time weather database comprises longitudes and latitudes in each of the districts where the electronic maps in the map database respectively belong.

6. The method as claimed in claim 5, wherein the navigation device outputs the electronic map and the background weather pattern corresponding to the current location by performing steps of:
comparing the longitude and the latitude of the current location with the longitudes and the latitudes in the map database and in the real-time weather database;
invoking from the map database one of said electronic maps that corresponds to the longitude and the latitude of the current location, and invoking from the real-time weather database one of said background weather patterns that corresponds to the longitude and the latitude of the current location; and
displaying the electronic map and the background weather pattern corresponding to the current location on the display device of the navigation device.

7. The method as claimed in claim 6, wherein the navigation device determines whether or not it is necessary to change the electronic map corresponding to the current location by performing steps of:
reading a longitude and a latitude of an updated current location;
determining whether or not the longitude and the latitude of the updated current location are outside a range of the longitudes and the latitudes of the district where the current location belongs; and
when the longitude and the latitude of the updated current location are outside the range of the longitudes and the latitudes of the district where the current location belongs, sending a change signal demanding the electronic map corresponding the current location be changed, and proceeding to a step for replacing the electronic map corresponding to the current location.

8. The method as claimed in claim 7, wherein, when the longitude and the latitude of the updated current location are not outside the range of the longitudes and the latitudes of the district where the current location belongs, the navigation device sends a no-change signal signifying there is no need to change the electronic map, and proceeds to the step for reading the plurality of positioning signals received by the positioning module to read another plurality of positioning signals received by the positioning module.

9. The method as claimed in claim 8, wherein the navigation device replaces the electronic map and the background weather pattern presently displayed on the display device with the electronic map and the background weather pattern corresponding to the updated current location by performing steps of:
comparing a longitude and a latitude of the updated current location with the longitudes and the latitudes in the map database and in the real-time weather database;
invoking from the map database one of said electronic maps that corresponds to the longitude and the latitude of the updated current location, and invoking from the real-time weather database one of said background weather patterns that corresponds to the longitude and the latitude of the updated current location; and
displaying the electronic map and the background weather pattern that correspond to the updated current location on the display device of the navigation device.
